(19) United States
(12) Patent Application Publication
(10) Pub. No.: US 2009/0162012 A1
(43) Pub. Date: Jun. 25, 2009

(54) Lens Arrangement for Optical Rotating Data Transmission Devices in Arbitrary Surrounding Media

(75) Inventor: Gregor Popp, Muenchen (DE)

Correspondence Address: DAFFER MCDANIEL LLP, P.O. BOX 684908, AUSTIN, TX, 78768, US

(73) Assignee: SCHLEIFRING UND APPARATEBAU GMBH, Fuerstenfeldbruck (DE)

(21) Appl. No.: 12/338,589

(22) Filed: Dec. 18, 2008

(30) Foreign Application Priority Data
Dec. 19, 2007 (DE) 102007061799.4

(51) Int. Cl. G02B 27/30; G02B 6/32

(52) U.S. Cl. 385/33; 359/362

(57) ABSTRACT

A rotating data transmission device for optical signals comprises two collimator arrangements for coupling light-waveguides, the collimator arrangements being rotatable relative to each other, and a derotating element being interposed in a light path between the collimator arrangements. At least one collimator arrangement comprises a lens system with a micro-lens array, and a light-waveguide holder firmly mounted to the micro-lens array with an intermediate space between the holder and the micro-lens array. At least one light-waveguide for supplying or collecting light to or from a micro-lens is fastened to both the micro-lens array and to the holder to prevent bending loads with attendant shifts of a mode field from acting upon the light-waveguide between the holder and the micro-lens array.

### PRIORITY CLAIM

This application claims priority to pending German Application No. 102007061799.4 filed on Dec. 19, 2007.

### BACKGROUND OF THE INVENTION

1. Field of the Invention

The invention relates to an optical rotating data transmission device and a lens system particularly for use in optical rotating data transmission devices, and also a method for manufacturing a lens system of this kind.

2. Description of Related Art

Various transmission systems are known for transmitting optical signals between units that are rotatable relative to each other.

An optical rotating data transmission system for a plurality of channels, having a Dove prism, is disclosed in DE 102006022023. Micro-lens arrays are provided for coupling-in or coupling-out light. Glass fibers for supplying light can be attached, for example directly to the micro-lens arrays. An arrangement of this kind is extremely space-saving. However, mechanical fixing of the fibers is not very stable. Alternatively, ferrules for accommodating and fastening the glass fibers are disclosed. These provide an extremely stable mechanical structure, but require relatively much space.

### BRIEF SUMMARY OF THE INVENTION

The invention is based on the object of providing at favorable cost an optical rotating data transmission device, and also a lens system for a rotating data transmission device of this kind, which can be manufactured to require small space and offers good mechanical support of light waveguides to prevent the light-waveguides from being subjected to tensile and bending loads close to their coupling-on positions with lenses. Furthermore, it is an object to describe a method for manufacturing a lens system of this kind.

In one embodiment, an optical rotating data transmission device comprises: a first collimator arrangement for coupling first light-waveguides; a second collimator arrangement for coupling second light-waveguides rotatable relative to the first collimator arrangement about a rotation axis; a derotating optical element located in a light path between the first collimator arrangement and the second collimator arrangement; wherein the first collimator arrangement and the second collimator arrangement comprises a substrate having a front surface on which micro-lenses are formed and an opposite rear surface through which light-waveguides are led for optical coupling with the micro-lenses, and a light-waveguide holder connected to the micro-lens array substrate; wherein the light-waveguide holder has a holding portion extending parallel along and at a given distance from the rear surface; and wherein at least one light-waveguide optically coupled to a micro-lens is connected both to the substrate and the holding portion.

In another embodiment, a lens system is provided for a collimator arrangement of an optical rotating data transmission device, the device comprising: a first collimator arrangement for coupling first light-waveguides, a second collimator arrangement for coupling second light-waveguides, supported to be rotatable relative to the first collimator arrangement about a rotation axis; a derotating optical element located in a light path between the first collimator arrangement and the second collimator arrangement; the lens system comprising: a micro-lens array having a substrate with a front surface on which micro-lenses are formed, and an opposite rear surface through which light-waveguides are led for coupling with the micro-lenses; a light-waveguide holder connected to the micro-lens array substrate and having a holding portion extending parallel along and at a distance from the rear surface of the micro-lens array; and at least one light-waveguide coupled to a micro-lens and connected both to the micro-lens array substrate and the holding portion.

In another embodiment, a method is provided for manufacturing a lens system for a collimator of an optical rotating data transmission device, comprising the steps of: manufacturing a micro-lens array having a substrate with a front surface on which micro-lenses are formed, and an opposite rear surface having openings for insertion of light-waveguides to be coupled with the micro-lenses; connecting a light-waveguide holder to the substrate and having a holding portion which extending parallel along and at a distance from the rear surface of the micro-lens array, and bore holes aligned with the openings for insertion of the light-waveguides; leading at least one light-waveguide through a bore hole in the holding portion and into an opening in the substrate for coupling with a micro-lens; attaching the at least one light-waveguide to the substrate with an adhesive applied on an entry side of the opening; and attaching the at least one light-waveguide to the holding portion of the holder with an adhesive applied to the light-waveguide inside the bore hole, with the light-waveguide maintained in a straight configuration between the bore hole and the opening in the substrate.

In another embodiment, a method is provided for manufacturing a lens system for a collimator of an optical rotating data transmission device, comprising the steps of: manufacturing a micro-lens array having a substrate with a front surface on which micro-lenses are formed, and an opposite rear surface having openings for insertion of light-waveguides to be coupled with the micro-lenses, and a light-waveguide holder connected firmly with the substrate and having a holding portion extending parallel along and at a distance from the rear surface of the micro-lens array; leading at least one light-waveguide transverse to the holding portion and through an opening in the substrate for coupling with a lens; attaching the at least one light-waveguide to the substrate with an adhesive applied on an entry side of the opening; and attaching the light-waveguides laterally to the holding portion of the holder with an adhesive applied to the light-waveguide with the light-waveguide maintained in a straight configuration between the holding portion and the opening in the substrate.

### BRIEF DESCRIPTION OF THE DRAWINGS

In the following, the invention will be described by way of example, without limitation of the general inventive concept, on examples of embodiment and with reference to the drawings.

FIG. 1 shows a first arrangement according to the invention;

FIG. 2 shows the attachment of a light-waveguide to a micro-lens array and a holder;

FIG. 3 shows a plan view of an arrangement in accordance with the invention;

FIG. 4 shows another plan view of an arrangement in accordance with the invention; and

FIG. 5 shows a rotating data transmission device in accordance with the invention.

### DETAILED DESCRIPTION OF PREFERRED EMBODIMENTS

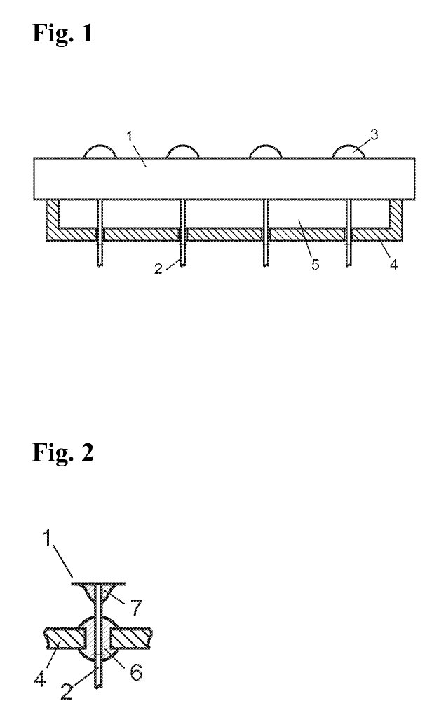

FIG. 1 shows a cross-section through a lens arrangement with a micro-lens array 1 and a holder 4. The micro-lens array comprises lenses 3 on one side and light-waveguides 2 on an opposite side of a substrate. The holder 4 is disposed on the micro-lens array 1 on the substrate side of the light-waveguides 2. In this example of embodiment, the holder 4 has a surface which extends parallel to the micro-lens array 1 and has bore holes for leading through the light-waveguides 2. The bore holes are aligned with respective entry openings for light-waveguides in the substrate. Furthermore, the holder 4 has legs extending perpendicularly from this surface for supporting it on the micro-lens array, the holder thus being formed as a bracket. Basically, this support may be achieved also in other ways. An intermediate space 5, typically containing air, is located between the micro-lens array 1 and the holder 4.

FIG. 2 illustrates a partial view of a light-waveguide 2 connected with a micro-lens array 1 and a holder 4 to have a straight configuration. For the sake of simplicity, the surface of the micro-lens array 1 is depicted here only as a line. The light-waveguide 2 is fastened to this surface by means of an adhesive 7. Furthermore, the light-waveguide 2 is fixed by means of an adhesive 6 inside and around edges of a bore hole passing through the holder 4. As shown, the bore hole is formed to have sufficient clearance for allowing the light-waveguide to be passed through before being fixed.

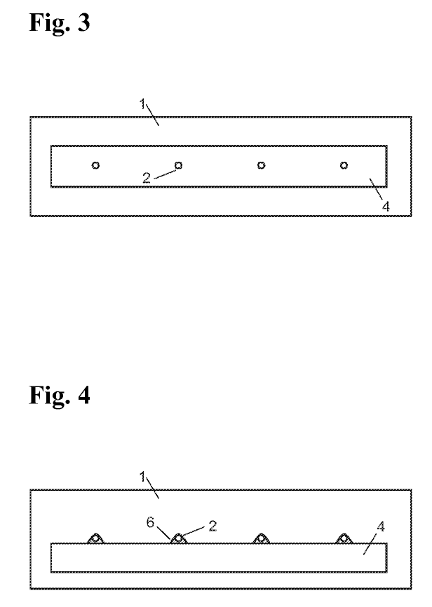

FIG. 3 shows a plan view of an arrangement in accordance with the invention. The holder 4 is mounted to the micro-lens array 1. The light-waveguides 2 are led through bore holes in the holder 4. Here the arrangement is illustrated simply as a one-dimensional linear arrangement of a plurality of waveguides 2. Of course, a two-dimensional arrangement of the light-waveguides within a surface also can be achieved.

FIG. 4 shows a view similar to that of FIG. 3. However, in this the holder 4 has no bore holes for accommodating the light-waveguides. Rather than this, the light-waveguides extending transversely to the holding member are fixed laterally to the holder by means of an adhesive. Alternatively, the light-waveguides also can be clamped to the holder under mechanical pressure. An improvement can be achieved when lateral grooves for accommodating the light-waveguides 2 are provided on the holder 4.

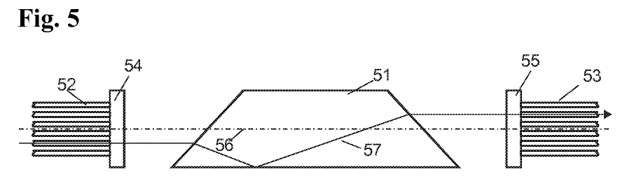

FIG. 5 shows in a schematic form a rotating data transmission device in accordance with the invention, having a derotating optical element. The optical rotating data transmission device comprises a first collimator arrangement 54 for coupling-on first light-waveguides 52, and also a second collimator arrangement 55 for coupling-on second light-waveguides 53. The second collimator arrangement 55 is supported to be rotatable relative to the first collimator arrangement 54 about a rotation axis 56. For compensation of the rotary movement, a derotating element in the form of a Dove prism 51 is located in the beam path between the first collimator arrangement 54 and the second collimator arrangement 55. Illustrated is an example of the beam path of a light beam 59 starting out from first light-waveguides 52 and passing via the first collimator arrangement 54, through the Dove prism 51, via the second collimator arrangement 55, and into the second light-waveguides 53. In accordance with the invention, at least one of the collimator arrangements 54, 55 is designed as a lens system of the invention, having a micro-lens array 1 and a holder 4.

In one embodiment, an optical rotating data transmission device is provided. The device comprises a first collimator arrangement 54 for coupling first light-waveguides 52, and also a second collimator arrangement 55 for coupling second light-waveguides 53. The second collimator arrangement 55 is supported to be rotatable relative to the first collimator arrangement 54 about a rotation axis 56. A derotating element in the form of a Dove prism 51, for example, is located in the beam path between the first collimator arrangement 54 and the second collimator arrangement 55 to compensate the rotary movement. In accordance with the invention, at least one of the collimator arrangements 54, 55 is designed to be a lens system with a micro-lens array 1 and a holder 4.

In another embodiment, a lens system is provided. The system comprises a micro-lens array 1 having at least one lens 3. Furthermore, at least one light-waveguide 2 is connected to the micro-lens array. Furthermore, a holder 4 with a holding portion is provided for supporting the at least one light-waveguide 2. The holder is connected firmly and rigidly to the micro-lens array, and the holding portion is disposed at a given, preferably short distance from the rear side of the micro-lens array. This distance is preferably within a range of 2 to 5 mm. The holder supports the at least one light-waveguide 2 optionally along its longitudinal axis and/or transverse thereto. Support of the at least one light-waveguide along its longitudinal axis results in an improved relief from tension and also, in particular, in further relief of the junction between the at least one light-waveguide 2 and the micro-lens array 1. Support transverse to the longitudinal axis of the at least one light-waveguide 2 reduces the mechanical stresses caused in the at least one light-waveguide 2 by bending. Distortions can change the squint angle of the micro-lens array. Thus, already a small bending load can lead to a shift of the mode field (the light-guiding region of the fiber) as a result of a minute change of refractive index in the latter Thus, If a shift of the mode field occurs close to the coupling-on position of the light-waveguide 2 in front of a lens, then the squint angle of the collimated beam changes. In an equivalent embodiment the at least one light-waveguide 2 is connected only indirectly to the micro-lens array 1. This is the case, for example, when a spacer, for example in the form of a glass plate, is additionally provided between the at least one light-waveguide 2 and the micro-lens array 1.

In an alternative embodiment, the at least one light-waveguide 2 is connected to the holder 4 by means of an adhesive. Suitable adhesives are, for example, epoxy resins. Preferably an at least slightly elastic mass is used as an adhesive, so that no mechanical stresses act on the site of the adhesive. Furthermore, in particular for use at different ambient pressures, the mass is free from bubbles. A silicone may also be used as an adhesive. The adhesive can comprise a filling material, for example a ceramic.

In another alternative embodiment, the at least one light-waveguide 2 is welded or heat-sealed to the holder 4.

Another alternative embodiment provides for the holding portion of the holder 4 to have bore-holes for accommodating the at least one light-waveguide 2.

It is preferable for the holder 4 to be open on at least one side, so that the at least one light-waveguide 2 is accessible for an adjusting tool in the region of its junction with the micro-lens array 1.

In an alternative embodiment, the at least one light-waveguide 2 is fastened laterally to the holder 4.

In another alternative embodiment, at least one lateral groove is provided on the holding portion of the holder 4 to accommodate the at least one light-waveguide 2.

In yet another alternative embodiment, the holder 6 comprises quartz glass.

In yet another embodiment, an optical rotating data transmission device is provided comprising at least one lens system described herein.

Alternatively, rotating data transmission devices, with or without a derotating element, such as single-channel rotating data transmission devices, can be equipped with lens systems as described herein. Similarly, rotating data transmission devices, for example, which make use of a mirror-coated trench or segments thereof as light guides, can be equipped with lens systems as described herein. The term micro-lens array as used here relates to all possible collimator arrangements in which at least one lens, preferably a multitude of lenses, is disposed on a glass carrier. A micro-lens array is manufactured preferably by micro-technological methods.

In yet another embodiment, a method is provided for manufacturing a lens system for optical rotating data transmission devices. The method comprises the steps of manufacturing a micro-lens array 1, attaching a holder 4 to the micro-lens array 1, and subsequently mounting at least one light-waveguide 2. The mounting can be effected by affixing with an adhesive and/or by welding the at least one light-waveguide 2 to the holder 4 and the micro-lens array.

1. An optical rotating data transmission device, comprising:
a first collimator arrangement for coupling first light-waveguides;
a second collimator arrangement for coupling second light-waveguides rotatable relative to the first collimator arrangement about a rotation axis; and
a derotating optical element located in a light path between the first collimator arrangement and the second collimator arrangement;
wherein the first collimator arrangement and the second collimator arrangement comprises a substrate having a front surface on which micro-lenses are formed, and an opposite rear surface through which light-waveguides are led for optical coupling with the micro-lenses, and a light-waveguide holder connected to the substrate;
wherein the light-waveguide holder has a holding portion extending parallel along and at a given distance from the rear surface; and
wherein at least one light-waveguide optically coupled to a micro-lens is connected both to the substrate and the holding portion.

2. The optical rotating data transmission device according to claim 1, wherein the distance between the holding portion of the holder and the rear surface is in a range of 2 to 5 mm.

3. The optical rotating data transmission device according to claim 1, wherein the holding portion of the holder is provided with through bore holes for accommodating the light-waveguides placed therein.

4. The optical rotating data transmission device according to claim 1, wherein the holder has legs directed perpendicular from the rear surface for supporting the holder on the substrate.

5. The optical rotating data transmission device according to claim 1, wherein the derotating optical element is a Dove prism.

6. The optical rotating data transmission device according to claim 1, wherein the derotating optical element is an Abbe-König prism.

7. The optical rotating data transmission device according to claim 1, wherein the holder is of the same material as the substrate.

8. The optical rotating data transmission device according to claim 1, wherein the holding portion of the holder is provided with grooves for accommodating the first and second light-waveguides.

9. The optical rotating data transmission device according to claim 1, wherein the at least one first or second light-waveguide is attached by means of an adhesive to the holder.

10. The optical rotating data transmission device according to claim 1, wherein the at least one first or second light-waveguide is held by means of an adhesive inside a through bore hole provided in the holding portion of the holder for leading through and accommodating the at least one first or second light-waveguide.

11. The optical rotating data transmission device according to claim 1, wherein the at least one first or second light-waveguide is welded to the holder.

12. The optical rotating data transmission device according to claim 1, wherein the at least one first or second light-waveguide is clamped to the holder under mechanical pressure.

13. A lens system for a collimator arrangement of an optical rotating data transmission device, the device comprising:
a first collimator arrangement for coupling first light-waveguides;
a second collimator arrangement for coupling second light-waveguides, supported to be rotatable relative to the first collimator arrangement about a rotation axis;
a derotating optical element located in a light path between the first collimator arrangement and the second collimator arrangement; and
the lens system comprising:
a micro-lens array having a substrate with a front surface on which micro-lenses are formed, and an opposite rear surface through which light-waveguides are led for coupling with the micro-lenses;
a light-waveguide holder connected to the micro-lens array substrate and having a holding portion extending parallel along and at a distance from the rear surface of the micro-lens array; and
at least one light-waveguide coupled to a micro-lens and connected both to the micro-lens array substrate and the holding portion.

14. The lens system according to claim 13, wherein the distance between the holding portion of the holder and the rear surface of the micro-lens array is in a range of 2 to 5 mm.

15. The lens system according to claim 13, wherein the holding portion has a surface which extends parallel to the micro-lens array and is provided with bore holes for leading through light-waveguides.

16. The lens system according to claim 15, wherein the holder has legs directed perpendicularly to the holding portion surface which extends parallel to the micro-lens array, for supporting the holder on the micro-lens array.

17. The lens system according to claim 13, wherein the holder consists of the same material as the micro-lens array.

18. The lens system according to claim 13, wherein the holding portion of the holder is provided with a through bore hole for leading through and accommodating the at least one light-waveguide.

19. The lens system according to claim 13, wherein the holding portion of the holder is provided with grooves for accommodating the at least one light-waveguide.

20. The lens system according to claim 13, wherein the at least one light-waveguide is attached by means of an adhesive to at least one of the holder and the micro-lens array.

21. The lens system according to claim 13, wherein the at least one light-waveguide is welded to at least one of the holder and the micro-lens array.

22. The lens system according to claim 13, wherein the at least one light-waveguide is mechanically clamped to the holder.

23. A method for manufacturing a lens system for a collimator of an optical rotating data transmission device, comprising the steps of:
manufacturing a micro-lens array having a substrate with a front surface on which micro-lenses are formed, and an opposite rear surface having openings for insertion of light-waveguides to be coupled with the micro-lenses;
connecting a light-waveguide holder to the substrate and having a holding portion extending parallel along and at a distance from the rear surface of the micro-lens array, and bore holes aligned with the openings for insertion of the light-waveguides;
leading at least one light-waveguide through a bore hole in the holding portion and through an opening in the substrate for coupling with a micro-lens;
attaching the at least one light-waveguide to the substrate with an adhesive applied on an entry side of the opening; and
attaching the at least one light-waveguide to the holding portion of the holder with an adhesive applied to the light-waveguide inside the bore hole, with the light-waveguide maintained in a straight configuration between the bore hole and the opening in the substrate.

24. A method for manufacturing a lens system for a collimator of an optical rotating data transmission device, comprising the steps of:
manufacturing a micro-lens array having a substrate with a front surface on which micro-lenses are formed, and an opposite rear surface having openings for insertion of light-waveguides to be coupled with the micro-lenses, and a light-waveguide holder connected firmly with the substrate and having a holding portion extending parallel along and at a distance from the rear surface of the micro-lens array;
leading at least one light-waveguide transverse to the holding portion and into an opening in the substrate for coupling with a micro-lens;
attaching the at least one light-waveguide to the substrate with an adhesive applied on an entry side of the opening; and
attaching the at least one light-waveguide laterally to the holding portion of the holder with an adhesive applied to the light-waveguide, with the light-waveguide maintained in a straight configuration between the holding portion and the opening in the substrate.
